(19) United States
(12) Patent Application Publication
(10) Pub. No.: US 2012/0062476 A1
(43) Pub. Date: Mar. 15, 2012

(54) HANDHELD ELECTRONIC DEVICE

(75) Inventor: KUAN-LIN WU, Tu-Cheng (TW)

(73) Assignee: HON HAI PRECISION INDUSTRY CO., LTD., Tu-Cheng (TW)

(21) Appl. No.: 12/906,905

(22) Filed: Oct. 18, 2010

(30) Foreign Application Priority Data
Sep. 9, 2010 (TW) 99130511

(51) Int. Cl. G06F 3/041

(52) U.S. Cl. 345/173

(57) ABSTRACT

A handheld device includes a display, a touch panel opposite to the touch panel, and a controller. When a point on the touch panel is touched, the touch panel outputs a first signal corresponding to the location of the point being touched. The controller receives the first signal, and outputs a second signal according to the first signal to control a cursor displayed on the display screen. The location of the cursor is corresponding to the location of the point on the touch panel.

### BACKGROUND

1. Technical Field

The present disclosure relates to handheld electronic devices.

2. Description of Related Art

A conventional handheld device, such as a mobile phone, may include a touch screen. The touch screen acts as an input device and an output device of the mobile phone. However, because screens of handheld devices are necessarily small, it is difficult for users to accurately select the objects.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a handheld electronic device.

FIG. 2 is a schematic diagram of the handheld electronic device of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

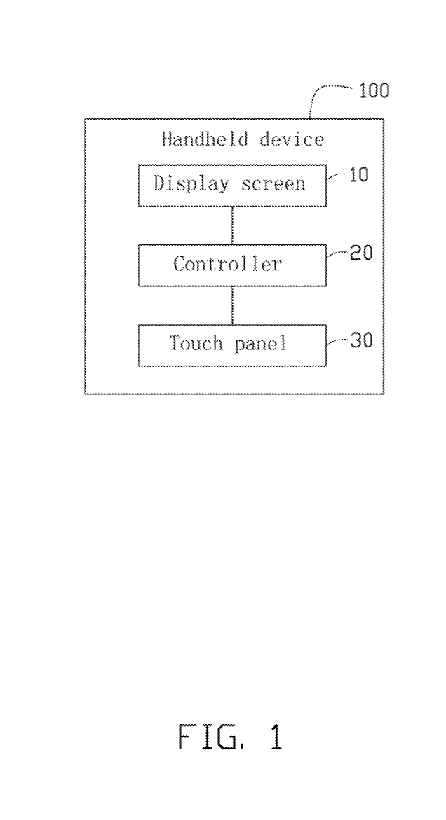

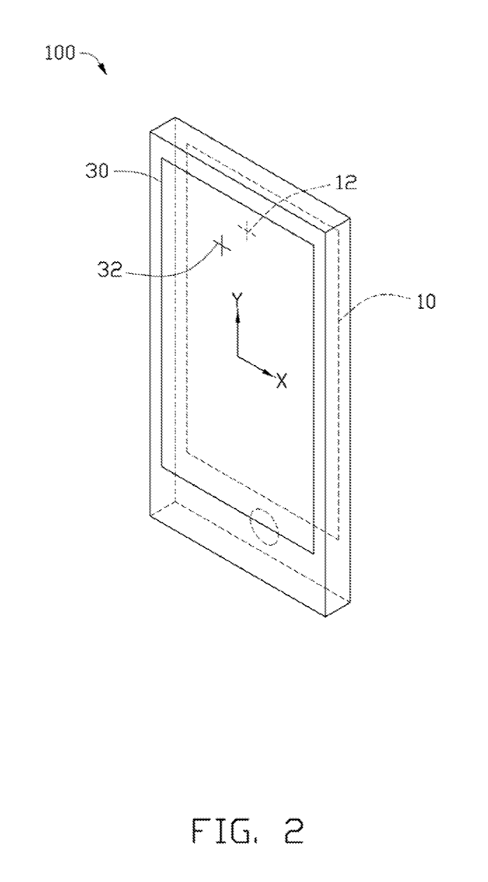

Referring to FIGS. 1 and 2, an exemplary embodiment of a handheld electronic device 100 includes a display screen 10, a controller 20, and a touch panel 30.

The display screen 10 is mounted on a first surface of the device 100. The touch panel 30 is mounted on a second surface of the device 100 opposite to the first surface, and corresponds to the display screen 10. The controller 20 is set in the device 100.

The touch panel 30 has a same size as the display screen 10. When a point 32 on the touch panel 30 is touched, the touch panel 30 outputs a first signal corresponding to coordinates of the point 32.

The controller 20 receives the first signal, and outputs a second signal according to the first signal to control a cursor 12 displayed on the display screen 10 to be located at the coordinates of the point 32. For operating, users can watch the display screen 10 of the handheld device 100, and control the handheld device 100 through the touch panel 30.

In the embodiment, a center of the touch panel 30 is regarded as an origin of a coordinate system. When the coordinates of the point 32 on the touch panel 30 are (20, 40), for example, the coordinates of the cursor 12 displayed on the display screen 10 are (20, 40).

In other embodiments, the display screen 10 may also be a touch screen. As a result, the users can control the handheld device 100 by either of the touch panel 30 and the display screen 10 as they wish. The visual feedback of the cursor 12 for the user, allows the user to correct their touch point if needed and so quickly and accurately use the touch panel 30 for input.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A handheld electronic device comprising:
a display screen;
a touch panel opposite to the display screen; and
a controller, wherein when a point on the touch panel is touched, the touch panel outputs a first signal corresponding to the location of the point being touched, the controller receives the first signal, and outputs a second signal according to the first signal to control a cursor displayed on the display screen, the location of the cursor is corresponding to the location of the point on the touch panel.

2. The handheld device of claim 1, wherein the display screen has a same size as the touch panel.

3. The handheld device of claim 1, wherein the location of the cursor is same as the location of the point on the touch panel.

4. The handheld device of claim 1, wherein the display screen is a touch screen.
